(19) United States
(12) Patent Application Publication
(10) Pub. No.: US 2024/0183420 A1
(43) Pub. Date: Jun. 6, 2024

(54) Axle Support Bearing for a Motor Vehicle Axle Driven in Particular by Means of an Electric Motor

(71) Applicant: Bayerische Motoren Werke Aktiengesellschaft, Muenchen (DE)

(72) Inventors: Arthur HUELSMANN, Muenchen (DE); Martin WALDMANN, Tutzing (DE)

(21) Appl. No.: 18/285,987

(22) PCT Filed: Feb. 28, 2022
(86) PCT No.: PCT/EP2022/054966

§ 371 Date: Oct. 6, 2023

(30) Foreign Application Priority Data
Apr. 7, 2021 (DE) 10 2021 108 655.8

(51) Int. Cl. F16F 1/38

(52) U.S. Cl. CPC F16F 1/38

(57) ABSTRACT

A bearing system for an axle of a double-track motor vehicle includes at least one rubber bearing. The stiffness of the rubber bearing in the vertical direction lies between a lower value and an upper value, depending on the stiffness of the rubber bearing in the longitudinal direction of the motor vehicle or its longitudinal axis. The lower value of the stiffness of the rubber bearing in the vertical direction is not smaller than 1.4 times the stiffness of the rubber bearing in the longitudinal direction. The upper value of the stiffness of the rubber bearing in the vertical direction is not greater than 10 times the stiffness of the rubber bearing in the longitudinal direction.

### BACKGROUND AND SUMMARY

The disclosure relates to an elastic bearing system of an axle carrier, in particular for a rear axle of a double-track motor vehicle.

Axle carriers are screwed at screwing points, screwed in a stiffly or elastically mounting manner, usually on longitudinal or transverse beams of a motor vehicle chassis. Here, the screwing direction is usually vertical in the vehicle, that is to say in the vehicle z-direction (also called the vehicle vertical direction), and more rarely in the direction of travel (also called the vehicle x-direction or vehicle longitudinal direction) or in the vehicle transverse direction (also called the vehicle y-direction).

An elastic bearing system for a rear axle carrier on a motor vehicle body, this rear axle carrier being suitable, in particular, for the installation of an electric drive, is described by DE 10 2013 210 576 A1. Here, a rear axle module is arranged on a vehicle body, the rear axle module comprising the rear axle carrier which, as viewed in the vehicle longitudinal direction, is connected to the vehicle body in the middle and rear region of the rear axle module, via in each case two middle and rear rear axle carrier bearings, the rear axle module additionally being connected to the vehicle body via front bearings in its front region. These front bearings are also rubber bearings and are designed in such a way that their stiffness in the z-direction is at least three times the stiffness in the x-direction, and the stiffnesses in the x-direction, y-direction and z-direction have a ratio with respect to one another of x:y:z=2:5:7, in order to provide an optimum solution for a conflict of objectives with regard to comfort, acoustics and driving dynamics for an implementation, meeting these challenges of an, in particular additional, rear axle drive in vehicles.

Vehicles with an internal combustion engine, an elastically mounted rear axle carrier and a rear axle drive are known. In the case of them, the rear axle drive is attached elastically to the rear axle carrier. The latter is mounted elastically on the vehicle body by way of rear axle carrier bearings.

In the case of vehicles with an electric drive on the rear axle, a much heavier electric drive is elastically mounted on the rear axle carrier instead of the up to now relatively light rear axle drive. One important property of the rear axle carrier rubber bearing is the stiffness in the direction of travel x. This contributes decisively to how great the accelerations are on the vehicle occupants, as a consequence of momentum from longitudinal excitations of the roadway, for example on account of small ridges or manhole covers, etc. in the roadway. The stiffness in the direction of travel x is therefore relevant for satisfactory driving comfort.

In the case of the design of the rear axle carrier bearings, there is then a conflict of objectives, particularly in the luxury vehicle segment, between satisfactory comfort in the case of roadway longitudinal excitations, for which the stiffness of the rear axle carrier bearings in the x-direction should be relatively soft, and satisfactory vibration comfort, for which the value of the stiffness of these bearings in the z-direction should be relatively hard. The ratio of the radial x-stiffness to the axial z-stiffness Cx:Cz is at least 0.9-13 here in accordance with the prior art. As a result, using customary rear axle carrier bearings, either disadvantageous, poorer vibration comfort arises in the case of a greater mass of the mounted drive, or disadvantageous longitudinal comfort in the case of selected stiffer rear axle carrier bearings.

In addition, there is a conflict of objectives between satisfactory rolling acoustics, for which the value of the stiffness of the rear axle carrier bearings in the y-direction should be relatively soft, and satisfactory vibration comfort, for which the value of the stiffness of these bearings in the z-direction should be relatively hard. Here, the ratio of the radial y-stiffness to the axial z-stiffness see Cy:Cz is from 4 to 20 in accordance with the prior art. As a result, using customary rear axle carrier bearings, either disadvantageous, poorer vibration comfort arises in the case of a greater mass of the mounted drive, or disadvantageous rolling acoustics arise in the case of selected stiffer rear axle carrier bearings.

In order to counteract the poorer vibration comfort, much more expensive hydraulically damped rubber bearings then have to be used as an alternative.

It is an object of the disclosure to avoid this. To this end, simple rear axle carrier bearings are to be used, the elastomer body of which manages without hydraulic damping, but which bearings are designed in such a way that the above-explained conflict of objectives are solved in such a way that a vehicle arises with satisfactory longitudinal comfort and/or satisfactory rolling acoustics and satisfactory vibration comfort.

According to the disclosure, the object is achieved by way of the characterizing features of this disclosure. Further refinements can also be found in this disclosure.

According to the disclosure, a bearing system for an axle of a double-track motor vehicle, with an axle carrier which is attached via an elastic linkage by means of at least one rubber bearing to a carrier, in particular of a motor vehicle body, each rubber bearing consisting at least of a rubber sleeve, the outer circumference of which is surrounded by a bushing and the inner circumference of which is applied in the axial longitudinal direction onto a bearing core, the rubber bearing linkage being positioned on the carrier in such a way that each rubber sleeve extends with its axially oriented longitudinal axis in the vertical direction of the motor vehicle, is characterized in that the stiffness of the rubber bearing in the vertical direction lies between a lower value and an upper value, depending on the stiffness of the rubber bearing in the longitudinal direction of the motor vehicle, that is to say in the direction of its longitudinal axis, the lower value of the stiffness of the rubber bearing in the vertical direction not being smaller than 1.4 times the stiffness of the rubber bearing in the longitudinal direction, and the upper value of the stiffness of the rubber bearing in the vertical direction not being greater than 10 times the stiffness of the rubber bearing in the longitudinal direction.

As an alternative or in addition, the bearing system for an axle of a double-track motor vehicle, with an axle carrier which is attached via an elastic linkage by means of at least one rubber bearing to a carrier, in particular of a motor vehicle body, each rubber bearing consisting at least of a rubber sleeve, the outer circumference of which is surrounded by a bushing and the inner circumference of which is applied in the axial longitudinal direction onto a bearing core, the rubber bearing linkage being positioned on the carrier in such a way that each rubber sleeve extends with its axially oriented longitudinal axis in the vertical direction of the motor vehicle, is characterized in that the stiffness of the rubber bearing in the vertical direction lies between a lower value and an upper value, depending on the stiffness of the rubber bearing in the transverse direction of the motor vehicle, that is to say in the direction of one of its transverse axes, the lower value of the stiffness of the rubber bearing in the vertical direction not being smaller than 0.3 times the stiffness of the rubber bearing in the transverse direction, and the upper value of the stiffness of the rubber bearing in the vertical direction not being greater than half the stiffness of the rubber bearing in the transverse direction.

A stiffness configuration of this type for a rubber bearing via its rubber sleeve and the use of this rubber sleeve for a vertically upright axle carrier bearing, in particular rear axle carrier bearing, for connecting the axle carrier to the body of the motor vehicle has the advantage that the properties of the axle carrier rubber bearing, in particular for electric drives integrated into the axle carrier or other heavyweight drive elements, represents, with regard to functioning costs, vibration comfort and rolling acoustics, a previously not yet recognized conglomeration of positively acting properties on drive and driving comfort, without compromises at the expense of the functional quality or the costs having to be made.

It is particularly advantageous here for at least two axle carrier rubber bearings of this type with the new stiffness ratios Cx/Cz and/or Cy/Cz to be used per axle carrier, in the case of which the stiffness in the sense of the longitudinal comfort in the x-direction and/or the rolling acoustics in the y-direction is therefore of sufficiently low configuration, but, in the sense of a reduction of drive vibrations, the stiffness in the z-direction is of sufficiently high configuration.

To this end, in particular, the following use locations and methods of use on the motor vehicle are preferred; as a rubber bearing for use in the rear axle carrier or front axle carrier, for mounting the axle carrier or elastically on the vehicle body.

To this end, stiffness ratios of this type, as described, can be used both for axle carrier bearing systems which, as viewed in the vehicle longitudinal direction and direction of travel, are attached by way of two front and two rear axle carrier bearings to the motor vehicle body in such a way that at least the two front (in the direction of forward travel) axle carrier bearings or at least two rear (in the direction of forward travel) axle carrier bearings or all four axle carrier bearings have a described rubber bearings stiffness distribution.

An axle carrier bearing system of this type can be particularly simply fastened to the motor vehicle if the bushing of each rubber bearing is attached to the vehicle body by means of in each case one threaded through bolt which is plugged through this bushing.

It is particularly advantageous for special comfort requirements if at least one rubber bearing is used which is additionally hydraulically damped in at least one of the damping directions of vertical direction and/or transverse direction and/or longitudinal direction. Here, the particular preferred direction which is hydraulically damped by way of the rubber bearings is the longitudinal direction of the motor vehicle.

It goes almost without saying that, in the case of the current prior art, the term “linkage on the vehicle body”, as is used in the first patent claim, inter alia, is self-evidently interpreted by a person skilled in the art such that the term “vehicle body” is equivalent to and representative of a linkage on a vehicle body or on a vehicle frame: a linkage of this type also comes into question for an electric drive model on an axle carrier or subframe or on other parts which are connected to the vehicle body and are not considered exclusively as belonging to a wheel suspension system, according to the vehicle design. This means that linkages on parts of this type, as linkages on the vehicle body, are also included by the scope of protection of the disclosure.

One preferred exemplary embodiment of the disclosure is shown in greater detail in the following description and the associated drawing, in which:

### BRIEF DESCRIPTION OF THE DRAWINGS

FIG. 1 shows a rubber bearing front axle carrier fastening means according to the disclosure to a motor vehicle chassis or body (not shown), in a three-dimensional view, with an indication of the physical coordinate directions for theoretically determining the load and deformation values on the rubber bearing.

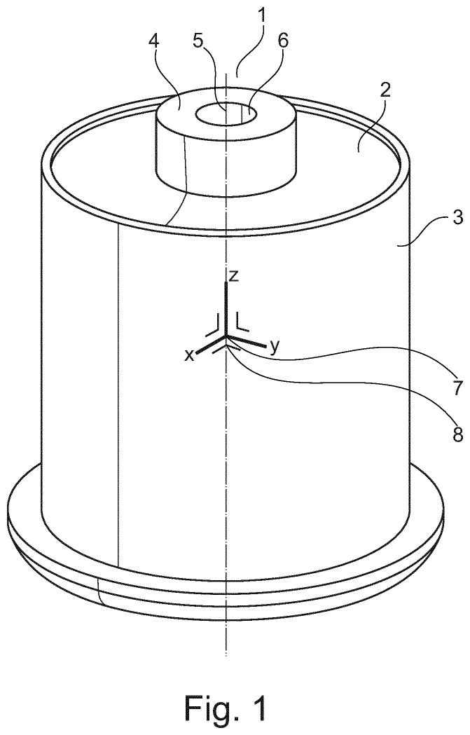

### DETAILED DESCRIPTION OF THE DRAWINGS

The FIGURE shows one embodiment of a rubber bearing 1 according to the disclosure for fastening (in accordance with the prior art) an axle carrier (not illustrated) to a carrier (not illustrated) of a motor vehicle body (not illustrated). In one preferred embodiment, together with three further rubber bearings (not illustrated) which, in particular, are of identical configuration to the rubber bearing 1, the rubber bearing 1 provides an elastic linkage of the axle carrier to at least two longitudinal beams or transverse beams (not shown) of the motor vehicle body. To this end, the rubber bearing 1 has an (in particular, metallic) bearing core 4 with a middle through hole 6, into which a threaded through bolt can be plugged (not illustrated) which establishes the connection to the motor vehicle body with the use of a threaded bushing (not illustrated) or a thread (not illustrated).

A rubber sleeve 2, seated with its non-visible outer circumference in a bushing 3, of the rubber bearing 1 is pushed with its non-visible inner circumference onto the outer circumference of the bearing core 4.

Installed in the motor vehicle, each rubber bearing 1 extends its axially directed longitudinal axis 5 in the vertical direction of the motor vehicle, and is oriented in this motor vehicle, in relation to the illustrated axes of coordinates 7, in such a way that the stiffnesses, configured differently in a direction-specific manner, of each rubber sleeve 2 to form a ratio of the radial x-stiffness, that is to say in the longitudinal direction, to the axial z-stiffness, that is to say in the vertical direction of the rubber bearing 1 of Cx/Cz of less than or equal to 0.7, in particular between 0.4 and 0.6.

In addition, the ratio of the radial y-stiffness, that is to say in the transverse direction, to the axial z-stiffness, that is to say in the vertical direction of the rubber bearing 1, of Cy/Cz can be less than or equal to 3.5, in particular can lie between 3 and 2.

Preferred combinations of stiffness values of the rubber bearing 1, from the abovementioned ratio values, depending on the direction in the axes of coordinates 7, are, for example:
Cx=335 N/mm, Cy=2200 N/mm, and Cz=1000 N/mm, or
Cx=600 N/mm, Cy=3000 N/mm, and Cz=1000 N/mm.

In order to understand the embodiments, it is considered self-evident that an extent in the transverse direction of the motor vehicle which is defined in the axes of coordinates 7 as the illustrated direction y extends in a horizontal plane 8 of the motor vehicle, orthogonally with respect to the vertical direction z illustrated in the axes of coordinates 7, and forms the horizontal plane 8 with the direction of forward travel x, likewise illustrated in the axes of coordinates 7, of the motor vehicle.

1.-6. (canceled)

7. A bearing system for an axle of a double-track motor vehicle, comprising:
an axle carrier which is attached with an elastic linkage via at least one rubber bearing to a carrier of a motor vehicle body, each rubber bearing consisting at least of a rubber sleeve, an outer circumference of which being surrounded by a bushing and an inner circumference of which is applied in an axial longitudinal direction onto a bearing core, the rubber bearing linkage being positioned on the carrier in such a way that each rubber sleeve extends with its axially oriented longitudinal axis in a vertical direction of the motor vehicle, wherein
the stiffness of the rubber bearing in the vertical direction lies between a lower value and an upper value, depending on the stiffness of the rubber bearing in the longitudinal direction of the motor vehicle or its longitudinal axis, the lower value of the stiffness of the rubber bearing in the vertical direction is not smaller than 1.4 times the stiffness of the rubber bearing in the longitudinal direction, and the upper value of the stiffness of the rubber bearing in the vertical direction is not greater than 10 times the stiffness of the rubber bearing in the longitudinal direction.

8. A bearing system for an axle of a double-track motor vehicle, comprising:
an axle carrier which is attached with an elastic linkage via at least one rubber bearing to a carrier of a motor vehicle body, each rubber bearing consisting at least of a rubber sleeve, an outer circumference of which is surrounded by a bushing and an inner circumference of which is applied in the axial longitudinal direction onto a bearing core, the rubber bearing linkage being positioned on the carrier in such a way that each rubber sleeve extends with its axially oriented longitudinal axis (z) in the vertical direction of the motor vehicle, wherein
the stiffness of the rubber bearing in the vertical direction lies between a lower value and an upper value, depending on the stiffness of the rubber bearing in a transverse direction of the motor vehicle, or one of its transverse axes (y), the lower value is not smaller than 0.3 times the stiffness of the rubber bearing in the transverse direction, and the upper value is not greater than half the stiffness of the rubber bearing in the transverse direction.

9. An axle carrier bearing system which, as viewed in the vehicle longitudinal direction, is attached by way of two front and two rear rubber bearings to the motor vehicle body, wherein at least the two front rubber bearings or at least the two rear rubber bearings or all four rubber bearings have a stiffness distribution according to claim 8.

10. The axle carrier bearing system according to claim 9, wherein the bushing of each rubber bearing is attached to the vehicle body via one threaded through bolt which is plugged through the bushing.

11. The axle carrier bearing system according to claim 10, wherein the at least one rubber bearing is used which is additionally hydraulically damped in at least one of the damping directions of vertical direction and/or transverse direction and/or longitudinal direction.

12. The axle carrier bearing system according to claim 11, wherein the one direction which is hydraulically damped by way of the rubber bearings is the longitudinal direction of the motor vehicle.
